(19) United States
(12) Patent Application Publication
(10) Pub. No.: US 2012/0327640 A1
(43) Pub. Date: Dec. 27, 2012

(54) DETACHABLE SOLAR PANEL LED DESK LAMP

(76) Inventor: Tin Go HUANG, Taichung City (TW)

(21) Appl. No.: 13/168,006

(22) Filed: Jun. 24, 2011

(51) Int. Cl. F21L 4/08

(52) U.S. Cl. 362/183

(57) ABSTRACT

The detachable solar panel LED desk lamp includes a desk lamp body and a solar cell unit. Through a solar panel on the solar cell unit, the light energy is transmitted to an electricity conversion control circuit board from the solar panel. The electricity conversion control circuit board converts the light energy into electric energy. The electric energy is stored in a battery unit for providing electricity to an LED light source seat of the desk lamp body. The light from the LED light source seat can be circulated and converted by the solar panel of the solar cell unit and then stored in the battery unit again. The present invention can be extensively used and is very convenient for use.

### BACKGROUND OF THE INVENTION

1. Field of the Invention

The present invention relates to a detachable solar panel LED desk lamp, and more particularly to a portable LED light source device used on a desk.

2. Description of the Prior Art

As shown in FIG. 6, a conventional desk lamp comprises a base (30), a support post (31), a light source seat (32), and a power cord (33). The bottom end of the support post (31) is coupled to the base (30), and the upper end of the support post (31) is coupled to the light source seat (32). The base (30) is connected with the power cord (33). The power cord (33) inputs electric power to drive the light source seat (32) for lighting. However, there are some problems existing in the conventional desk light.

1. Limited use function: The power cord inputs electric power to drive the light source seat for lighting. If there is no socket for supplying electric power, the light source seat is unable to light, so the use function is limited.

2. Inconvenient use. The power cord inputs electric power to drive the light source seat for lighting. This desk lamp cannot be used outside without a socket. Besides, the power source cannot be stored for use and circulated for reuse, so it is not convenient for use.

Accordingly, the inventor of the present invention has devoted himself based on his many years of practical experiences to solve these problems.

### SUMMARY OF THE INVENTION

The primary object of the present invention is to provide a detachable solar panel LED desk lamp which can overcome the problems existing is the prior art.

The detachable solar panel LED desk lamp of the present invention comprises a desk lamp body and a solar cell unit. The desk lamp body comprises a base, a foldable pipe and an LED light source seat. The foldable pipe is coupled to the LED light source seat and the base. The base has an accommodation trough and a control switch. The accommodation trough is provided with a conductive connection port. The conductive connection port is connected with the control switch. The solar cell unit comprises a solar panel and a housing. The housing is provided with an electricity conversion control circuit board, a battery unit and a conductive socket. The electricity conversion control circuit board, the battery unit and the conductive socket being connected with one another, the solar panel being coupled to the housing, the solar panel being connected with the electricity conversion control circuit board in the housing, the conductive socket in the housing being connected with the conductive connection port in the accommodation trough of base of the desk lamp body.

Thereby, the solar cell unit is received in the accommodation trough of the base. The engaging concaves on the outer side of the housing of the solar cell unit engage with the resilient engaging plates in the accommodation trough of the base. The conductive socket in the housing is connected with the conductive connection port in the accommodation trough of base of the desk lamp body. By the solar panel on the solar cell unit, the light energy is transmitted to the electricity conversion control circuit board from the solar panel. The electricity conversion control circuit board converts the light energy into electric energy. The electric energy is stored in the battery unit for providing electricity to the LED light source seat of the desk lamp body. The light from the LED light source seat can be circulated and converted by the solar panel of the solar cell unit and then stored in the battery unit again. The present invention can be extensively used and is very convenient for use.

### BRIEF DESCRIPTION OF THE DRAWINGS

FIG. 1 is a perspective view according to a preferred embodiment of the present invention;

FIG. 2 is an exploded view according to the preferred embodiment of the present invention;

FIG. 3 is a front view according to the preferred embodiment of the present invention;

FIG. 4 is a schematic view according to the preferred embodiment of the present invention when in use;

FIG. 5 is a top schematic view according to the preferred embodiment of the present invention when in use; and

FIG. 6 is a perspective view of a conventional desk lamp.

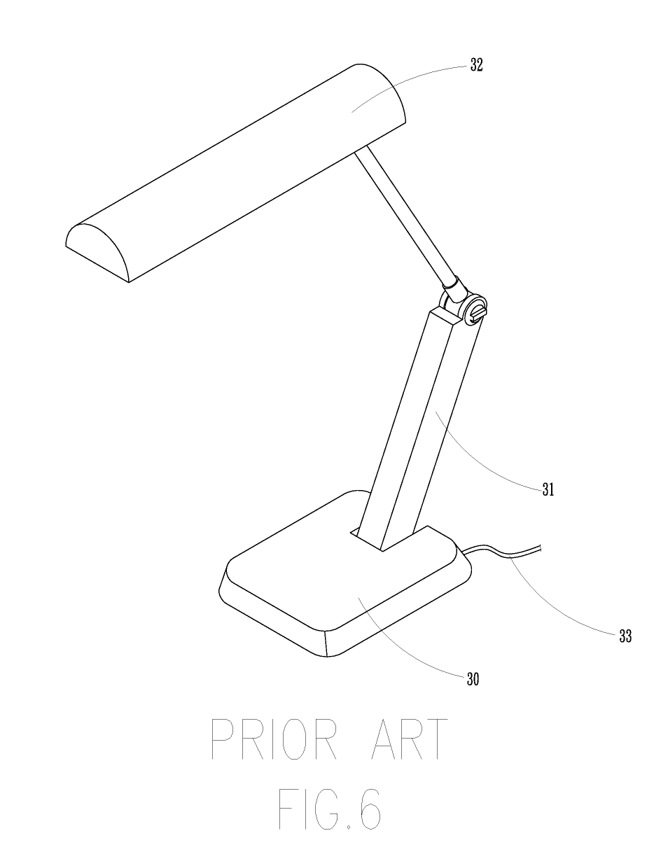

### DETAILED DESCRIPTION OF THE PREFERRED EMBODIMENTS

Embodiments of the present invention will now be described, by way of example only, with reference to the accompanying drawings.

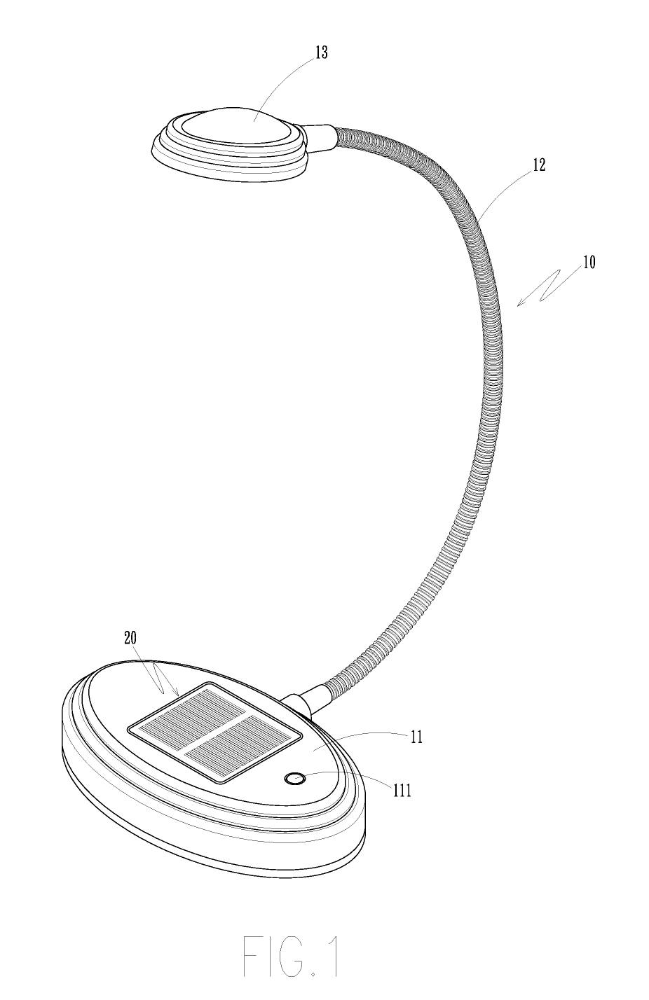

As shown in FIG. 1 through FIG. 3, the detachable solar panel LED desk lamp according to a preferred embodiment of the present invention comprises a desk lamp body (10) and a solar cell unit (20).

The desk lamp body (10) comprises a base (11), a foldable pipe (12), and an LED light source seat (13). The foldable pipe (12) comprises a conductive wire (not showing in drawings) therein. The foldable pipe (12) has a bottom end coupled to base (11) and a top end coupled to the LED light source seat (13) which is connected with one end of the conductive wire. The base (11) has an accommodation trough (110) and a control switch (111). The accommodation trough (110) is provided with a conductive connection port (110A) and a plurality of resilient engaging plates (110B). The conductive connection port (110A) is connected with another end of the conductive wire, which is away from the LED light source seat (13). The conductive connection port (110A) is connected with the control switch (111).

The solar cell unit (20) comprises a solar panel (21) and a housing (22). An outer side of the housing (22) has a plurality of engaging concaves (220). The housing (22) is provided with an electricity conversion control circuit board (221), a battery unit (222) and a conductive socket (223). The electricity conversion control circuit board (221), the battery unit (222) and the conductive socket (223) are connected with one another. The solar panel (21) is coupled to the housing (22). The solar panel (21) is connected with the electricity conversion control circuit board (221) in the housing (22). The solar cell unit (20) is received in the accommodation trough (110) of the base (11). The engaging concaves (220) on the outer side of the housing (22) of the solar cell unit (20) engage with the resilient engaging plates (110B) in the accommodation trough (110) of the base (11). The conductive socket (223) in the housing (22) is connected with the conductive connection port (110A) in the accommodation trough (110) of base (11) of the desk lamp body (10). Thus, the solar panel LED desk lamp of the present invention is completed.

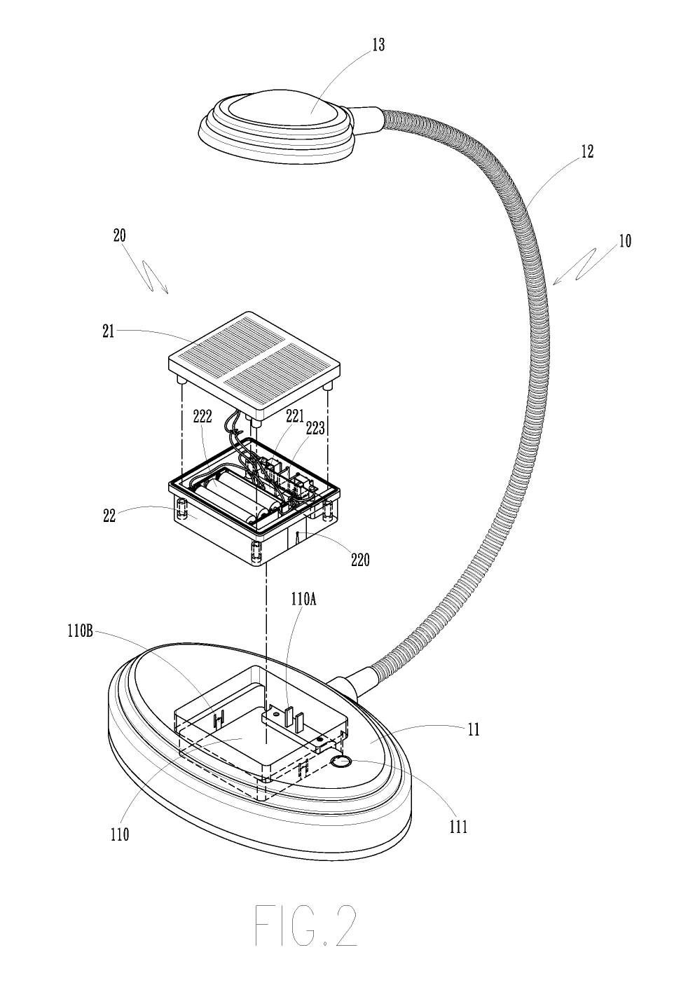

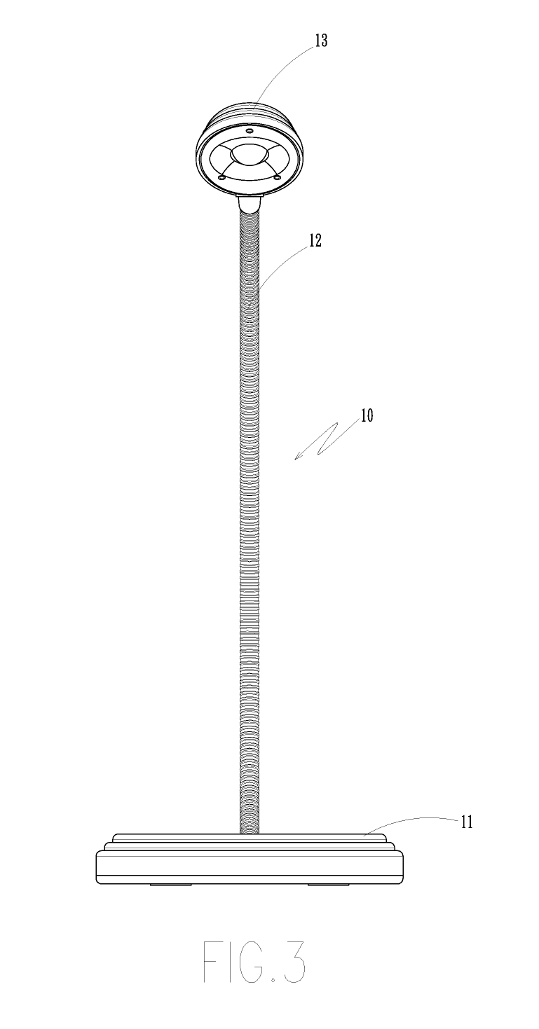

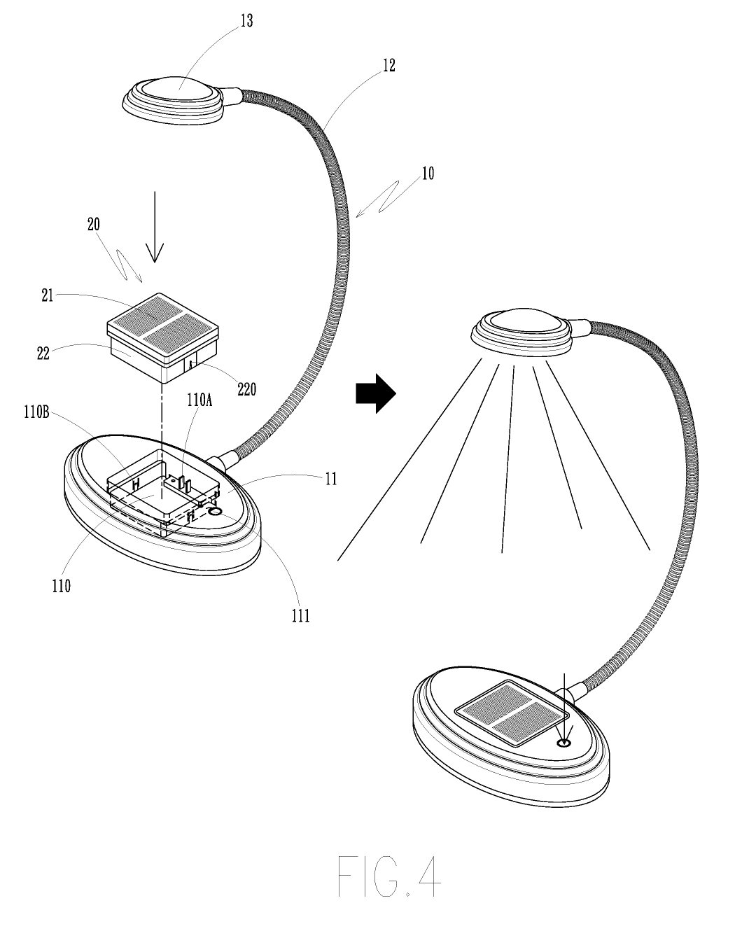

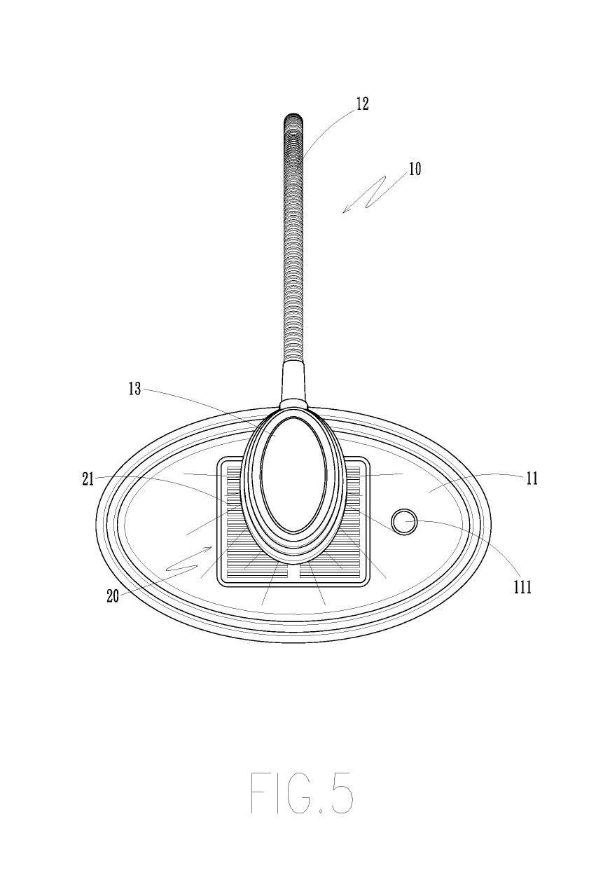

FIG. 2 is an exploded view according to the preferred embodiment of the present invention. FIG. 3 is a front view according to the preferred embodiment of the present invention. FIG. 4 is a schematic view according to the preferred embodiment of the present invention when in use. FIG. 5 is a top schematic view according to the preferred embodiment of the present invention when in use. The solar cell unit (20) is received in the accommodation trough (110) of the base (11). The engaging concaves (220) on the outer side of the housing (22) of the solar cell unit (20) engage with the resilient engaging plates (110B) in the accommodation trough (110) of the base (11). The conductive socket (223) in the housing (22) is connected with the conductive connection port (110A) in the accommodation trough (110) of base (11) of the desk lamp body (10). By the solar panel (21) on the solar cell unit (20), the light energy is transmitted to the electricity conversion control circuit board (221) from the solar panel (21). The electricity conversion control circuit board (221) converts the light energy into electric energy. The electric energy is stored in the battery unit (222) for providing electricity to the LED light source seat (13) of the desk lamp body (10). The light from the LED light source seat (13) can be circulated and converted by the solar panel (21) of the solar cell unit (20) and then stored in the battery unit (222) again. The present invention can be extensively used and is very convenient for use. The present invention has the following advantages:

1. Extensive use: By the solar panel on the solar cell unit, the light energy is transmitted to the electricity conversion control circuit board from the solar panel. The electricity conversion control circuit board converts the light energy into electric energy. The electric energy is stored in the battery unit for providing electricity to the LED light source seat of the desk lamp body. The desk lamp of the present invention can be used indoors or outdoors, without the limitation of socket, so it can be extensively used.

2. Convenient use: The light from the LED light source seat can be circulated and converted by the solar panel of the solar cell unit and then stored in the battery unit again. The desk lamp of the present invention is very convenient for use.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A detachable solar panel LED desk lamp, comprising:
a desk lamp body, the desk lamp body comprising a base, a foldable pipe and an LED light source seat, the foldable pipe being coupled to the LED light source seat and the base, the base having an accommodation trough and a control switch, the accommodation trough being provided with a conductive connection port, the conductive connection port being connected with the control switch; and
a solar cell unit, the solar cell unit comprising a solar panel and a housing, the housing being provided with an electricity conversion control circuit board, a battery unit and a conductive socket, the electricity conversion control circuit board, the battery unit and the conductive socket being connected with one another, the solar panel being coupled to the housing, the solar panel being connected with the electricity conversion control circuit board in the housing, the conductive socket in the housing being connected with the conductive connection port in the accommodation trough of base of the desk lamp body.

2. The detachable solar panel LED desk lamp as claimed in claim 1, wherein the accommodation trough of the base of the desk lamp body is provided with a plurality of resilient engaging plates and an outer side of the housing has a plurality of engaging concaves, when the solar cell unit is received in the accommodation trough of the base of the desk lamp body, the engaging concaves on the outer side of the housing of the solar cell unit engage with the resilient engaging plates in the accommodation trough of the base.

3. The detachable solar panel LED desk lamp as claimed in claim 1, wherein the foldable pipe comprises a conductive wire therein, the foldable pipe having a bottom end coupled to base and a top end coupled to the LED light source seat which is connected with one end of the conductive wire, another end of the conductive wire being connected to the conductive connection port.
